(19) United States
(12) Patent Application Publication
(10) Pub. No.: US 2026/0079507 A1
(43) Pub. Date: Mar. 19, 2026

(54) BALLOON INFLATION SYSTEM AND METHODS

(71) Applicant: Anagram International, LLC, Eden Prairie, MN (US)

(72) Inventors: Jamie Merlyn Lindell, Rosemount, MN (US); Michael John Hastings, Maple Grove, MN (US); Robert William Hajlo, Maplewood, MN (US); Darrick Paul Checco, Mayer, MN (US)

(21) Appl. No.: 18/886,490

(22) Filed: Sep. 16, 2024

(51) Int. Cl. G05D 11/00; A63H 27/10

(52) U.S. Cl. CPC G05D 11/001; A63H 27/10; A63H 2027/1033

(57) ABSTRACT

The present disclosure relates generally to a system for inflating a balloon and more particularly to a system and methods by which parameters for an inflation process are defined based on design and location of a balloon. Particularly, the system is configured to, automatically or in response to a user input, execute an inflation process to facilitate providing a defined minimum amount of a lighter-than-air gas followed by one or more supplemental gases to create a mixture within the balloon. Advantageously, the system may be configured to optimize an amount of each gas injected based on a design and location of the balloon and output an interface including costs, savings, and parameters relating to the location, design, and/or gaseous mixture.

### FIELD OF THE INVENTION

The invention relates generally to a system for inflating a balloon and more particularly to a system and methods by which parameters for an inflation process are defined based on design and location of a balloon.

### BACKGROUND

Balloons are commonly used for novelty purposes and may be sold at fairs, circuses, restaurants, gift shops, and the like. Typically, a balloon becomes buoyant under normal atmospheric conditions by injecting a gaseous mixture, which may also give the balloon a more attractive appearance.

Conventional systems for inflating a balloon often include a tank or cannister containing a compressed gas. Generally, the compressed gas within a tank or cannister includes a mixture including at least one lighter-than-air gas, such as helium. There are, however, several deficiencies associated with conventional inflating devices.

For instance, conventional systems often rely on an operator to ensure that the balloon is not under or over inflated. Specifically, typical inflation systems require an operator to insert the balloon onto a nozzle that is in communication with the compressed gas and determine a desired volume to be injected based on simply monitoring the inflation process. Inherently, this often results in under inflation, thereby limiting the period that the balloon remains buoyant. On the other hand, in an effort to ensure that the balloon remains afloat, operators often over inflate the balloon, which may result in an explosion including the projection of particles.

Another shortcoming of conventional systems includes inflating balloons with a predetermined gaseous mixture that fails to consider various parameters, such as design of the ballon and the location of inflation. As mentioned above, balloons are commonly filled with a mixture of air and a lighter-than-air gas, typically helium. The time that a balloon will remain buoyant and afloat is often associated with the amount of helium within a gas mixture and various environmental conditions. By ignoring environmental conditions, conventional inflation systems often fail to inject an optimal mixture of air and helium. Moreover, determining a specific amount of helium based on various parameters may result in substantial cost savings, especially in view of the global helium shortage that has resulted in an increased cost of this gas and often prohibited routine use.

Therefore, there is a need for a system and methods by which a gaseous mixture is determined for inflation of a balloon based on design and location. The present invention satisfies this need.

### SUMMARY

The present disclosure relates generally to a system for inflating a balloon and more particularly to a system and methods by which parameters for an inflation process are defined based on design and location of a balloon. Particularly, the system is configured to, automatically or in response to a user input, execute an inflation process to facilitate providing a defined minimum amount of a lighter-than-air gas followed by one or more supplemental gases to create a mixture within the balloon. Advantageously, the system may be configured to optimize an amount of each gas injected based on a design and location (including environmental conditions) of the balloon and output an interface including costs, savings, and parameters relating to the location, design, and/or gaseous mixture.

In operation, the system may be configured to receive design data corresponding to a balloon. Design data may include at least one of a balloon volume and a balloon mass. For example, the system may include one or more sensors configured to obtain design data based on an identifier of the balloon. As another example, the one or more sensors may be configured to obtain design data based on analyzing a structure or features of the balloon. It is also contemplated that design data may be manually input by a user.

Further, the system may be configured to obtain location information and environmental conditions corresponding to a location of the balloon to be inflated. Environmental conditions may include an elevation and a real-time temperature. For example, the system may obtain environmental conditions based on a geolocation or GPS sensor. Additionally, the system may communicate with a third-party device (e.g., a smartphone of a user) to request and obtain location information and environmental conditions.

In one aspect, the system may determine or define inflation parameters for inflating the balloon to achieve an optimal buoyancy. For instance, the system may define a minimum amount of a lighter-than-air gas required to obtain a balloon lift. The amount of a lighter-than-air gas defined by a system may be based on design data, location information, and/or one or more environmental conditions.

Once inflation parameters are defined, the system may execute an inflation process. The inflation process may include providing, via an outlet tube or port, the determined minimum amount of a lighter-than-air gas. Then, the system may be configured to inject, via the same outlet tube, one or more supplemental gases to create a mixture within the balloon corresponding to the design data and/or said environmental conditions. It is contemplated that the gas mixture may be injected into said balloon in response to a user input. Alternative, the inflation process may be executed in response to detecting the balloon proximate an outlet tube. Moreover, the system may include one or more regulators configured to measure an internal pressure of the balloon and switch between a lighter-than-air gas and a supplemental gas.

The system may further be configured to display output values corresponding to an inflation process, including design data and environmental conditions. Moreover, the system may output a cost amount associated with the defined amount of lighter-than-air gas. Further, a savings amount associated with a defined amount of lighter-than-air gas provided to the balloon may be output to the user.

While the present disclosure is susceptible to various modifications and alternative forms, specific exemplary embodiments thereof have been shown by way of example in the drawings and have herein been described in detail. It should be understood, however, that there is no intent to limit the present disclosure to the particular embodiments disclosed, but on the contrary, the intention is to cover all modifications, equivalents, and alternatives falling within the scope of the present disclosure as defined by the appended claims.

### BRIEF DESCRIPTION OF THE DRAWINGS

Embodiments are illustrated by way of example and not limitation in the figures in the accompanying drawings, in which like references indicate similar elements and in which:

FIG. 1 illustrates an exemplary system that may be used to implement the methods according to the present disclosure;

FIG. 2 is a flowchart illustrating an exemplary method for executing an inflation process;

FIG. 3 is a flowchart illustrating an exemplary method for identifying a balloon product and corresponding design data;

FIG. 4 is a flowchart illustrating an exemplary method for obtaining location information and defining inflation parameters;

FIG. 5 is a flowchart illustrating an exemplary method for injecting a determined amount of a lighter-than-air gas into an identified balloon product;

FIG. 6 illustrates an exemplary inflation system configured to inflate a balloon according to defined parameters based on location information and design data;

FIG. 7 illustrates an exemplary user interface for displaying inflation parameters including location information corresponding to a low altitude and high temperature region;

FIG. 8 illustrates an exemplary user interface for displaying inflation parameters including location information corresponding to a high altitude and low temperature region;

FIG. 9A illustrates a balloon that has been inflated according to defined inflation parameters to obtain a desired balloon lift;

FIG. 9B illustrates the balloon of FIG. 9A secured to a scale to measure balloon lift;

FIG. 10 is an exemplary computing system that may be used for implementation of all or a portion of the present disclosure; and

FIG. 11 is an exemplary cloud computing system that may be used for implementation of all or a portion of the present disclosure.

### DETAILED DESCRIPTION OF THE INVENTION

The present disclosure relates generally to a balloon inflation system and more particularly to a system and methods by which a gaseous mixture is determined for inflation of a balloon based on design and location. Particularly, the system is configured to, automatically or in response to a user input, execute an inflation process to facilitate providing a determined minimum amount of a lighter-than-air gas followed by one or more gases to create a mixture within the balloon. Advantageously, the system may be configured to optimize an amount of each gas injected based on a design and location of the balloon and output an interface including costs, savings, and parameters relating to the location, design, and/or gaseous mixture.

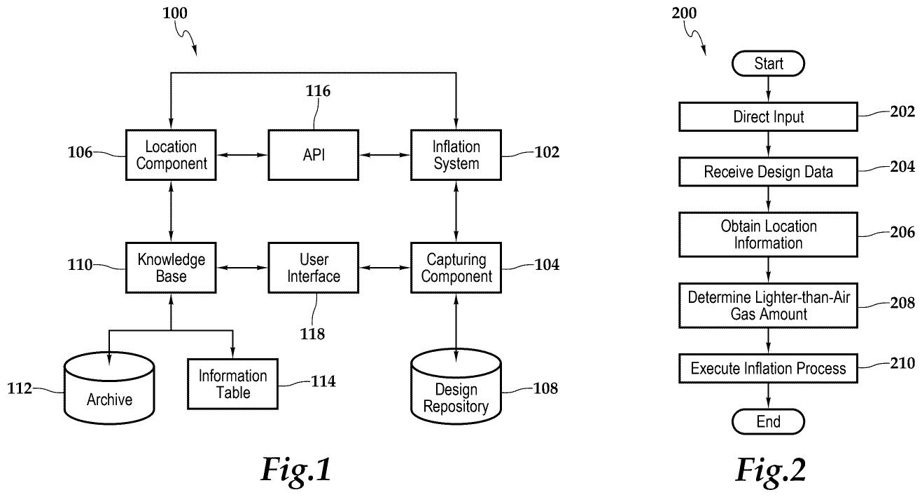

Turning to the figures, FIG. 1 illustrates an exemplary system 100 that may be used for implementation of all or a portion of the processes detailed below. As shown, system 100 may include an inflation system 102, a capturing component 104, and a location component 106. While certain components of system 100 are shown as separate interoperating systems, it is contemplated that functions performed by these components may be subsystem components of a single integrated system.

Inflation system 102 may be configured to execute an inflation process in accordance with the techniques described herein. For example, inflation system 102 include a gas inflator for inflating and deflating an expandable member. More specifically, inflation system 102 may be configured to receive and process data to accurately size and inflate (digitally or electronically) one or more ballons, such as foil balloons or latex balloons. Data received by inflation system 102 may be input by a user, obtained from a third-party device, and/or collected by one or more components of system 100, as detailed below.

Inflation system 102 may include various components for delivering one or more gases to a balloon. For instance, gas inflator may include one or more inlet ports in fluid communication with one or more high-pressure gas or fluid sources, such as an air compressor, a helium tank, a nitrogen tank, and the like. Moreover, inflation system 102 may include one or more outlet ports in communication with a control mechanism. Control mechanism may include one or more sensors, control valves, regulators, flowmeters, switches and/or buttons for controlling gas flow. For example, control mechanism may include a switch for switching between gas sources. As another example, control mechanism may include an inflation and a deflation button to, for example, facilitate injecting one or more gases or removing a gaseous mixture.

Capturing component 104 may implement a variety of recognition techniques for obtaining one or more inflation parameters that may be used during the inflation process executed by inflation system 102. For instance, capturing component 104 may identify a specific balloon based on an express identifier (e.g., watermarks and barcodes) or based on features of the balloon (e.g., size, shape, color, pattern, material, and the like). Other examples of data captured may include image data, video data, audio data, and the like. It is contemplated that, image or video data may be captured in real time by, for example, a camera, a scanner, an application configured to capture data, or other capturing device of system 100 or communicatively coupled with system 100.

Capturing component 104 may also be configured to support single and multi-device implementations. For instance, in a single device implementation, capturing component 104 may include a single device that captures and processes data corresponding to a balloon product. Alternatively, in a multi-device implementation, aspects of capturing component 104 may be distributed across two or more devices. For example, a first imaging device may capture content data and transfer the captured content data to a computing device configured to process the captured content.

Capturing component 104 may include one or more hardware, software, or firmware components that implements the functions described herein. Capturing component 104 may be configured to communicate with other components of the system 100 or third-party components to, for example, obtain data corresponding to information captured, process captured imagery, and the like.

Capturing component 104 may further include a sensor array configured to scan sources of different technologies including, for example, laser scanners, Radio Frequency Identification Devices (RFID), weight scales, or multi-pixel image sensor arrays. The image array sensor may be distinguished by operating software and includes, for example, a 1-D imager, a 2-D imager, an optical character recognition reader, a pattern recognition device, and a color recognition device. Capturing component 104 may further include one or more software applications. Software application may facilitate decoding machine-readable symbology on a balloon provided within a target or captured image. Machine readable symbology or encoded symbology may refer to a representation of an information element, such as a barcode or alphanumeric characters. For example, capturing component 104 may capture and decode one or more identifiers, such as one-dimensional barcodes (e.g., Uniform Product Codes) and two-dimensional indicia (e.g., QR codes).

Moreover, capturing component 104 may facilitate image processing such that features (e.g., boundaries, contours, shapes, or configurations) may be automatically detected and distinguished for product recognition purposes. For example, features of an image may be matched to features stored in a design repository 108 for identifying a source or model of a balloon. Design repository 108 may include additional information corresponding to attributes of an identified balloon, such as volume, mass, lift, materials, conductivity, and the like.

One or more components of system 100 may further facilitate performing feature extraction and classification operations. For instance, feature extraction may include assigning numeric values, or feature vectors, to key features of a balloon. Classification may be performed by a classifier configured to compare feature vectors of third-party content to feature vectors of content captured by system 100. It is further contemplated that feature vectors of captured content may be pretrained into a neural network (e.g., a composite model) to, for example, determine a match with an existing balloon design. Through repeated exposure, system 100 may be self-learning and configured to collect and associate information about captured fingerprints, weights, colors, and related features with one or more balloon products.

Location component 106 may be configured to, automatically or in response to a user input, determine a geographical location of the balloon needing inflation. For example, location component 106 may demodulate GPS signals to ascertain positional data. Other methods for determining a geographical location may be based on an IP network, cellular triangulation, and other geo-location-based protocols or techniques.

Location component 106 may further obtain one or more real-time environmental conditions or parameters corresponding to an identified location. Examples of environmental conditions corresponding to an identified location include elevation, temperature, humidity, air pressure, wind speeds, weather, and the like. Environmental conditions information may be used for optimizing the type and amount of each gas source used during the inflation process, as further detailed below.

In system 100 of FIG. 1, the interaction between inflation system 102, capturing component 104, and location component 106, and that which results from that interaction may be facilitated using an applications program interface (“API”) 114. In particular, API 116 may facilitate the bi-directional association between the attributes of a balloon from design repository 108 and the information used for executing an inflation process, which may be provided through knowledge base 108.

Knowledge base 108 may be used to provide access to information stored in an archive 112 or information table 114 corresponding to a gaseous mixture. Particularly, the type and amounts of gases used to inflate an identified balloon may be based on balloon design characteristics—such as volume and weight of an identified balloon—and geographic parameters—such as elevation and temperature—of an identified location. For example, system 100 may match design characteristics and environmental conditions to determine a minimum amount of a lighter-than-air gas for inflation of the identified balloon. It is further contemplated that system 100 may access information corresponding to local communities, electrical commissions, and electrical municipalities/companies to, for example, identify an acceptable breakdown voltage strength across a balloon surface and within the balloon through the inflation of one or more gases.

A user interface 118 of system 100 may display a virtual representation of the identified balloon and include various interactive components, such as descriptive components, graphical components, and temporal elements. The user interface may further display descriptive drawings, callouts, and captions that depict or describe, for example, the balloon design characteristics or attributes, parameters associated with an identified location, costs corresponding to available gas sources, and savings corresponding to using the determined minimum amount of a lighter-than-air gas, such as helium. System 100 may further facilitate interacting with one or more interactive components of user interface 118 to retrieve, input, display, or record information. For instance, in response to a user input changing one or more values displayed, system 100 may adjust the remaining parameters and attributes to optimize an amount of each gas injected based on a design and location of the balloon.

### Exemplary Flowcharts

FIG. 2 illustrates a flowchart 200 for executing an inflation process. The method of operation begins and, in step 202, the system may detect an input. Examples of inputs that the system can detect include mouse clicks, typed text, touch, gestures, utterances, gaze data, image data. Moreover, the system may be configured to detect inputs via one or more sensors or a group/array of sensors, such as an optical sensor configured to detect nearby objects in the environment such as a bar code or QR code corresponding to a balloon product or model.

In step 204, the system may receive design data corresponding to the detected input. Design data may include one or more attributes of a balloon. Examples of attributes may include balloon volume and balloon mass. Other attributes are contemplated, such as a materials, layers, optimal lift, geometry or dimensions, tensile strength, transparency, reflectivity, barrier properties, electrical insulation, and the like.

In step 206 of FIG. 2, the system may obtain location information. In step 208, the system may determine a minimal amount of lighter-than-air gas amount necessary to achieve a balloon lift based on design data and location information. Examples of a lighter-than-air gas include helium, hydrogen, air, neon, nitrogen, ammonia, methane, carbon monoxide, and other gases that have a density lower than normal atmospheric gases. In step 210, the system may execute an inflation process, as further detailed below.

FIG. 3 is a flowchart 300 providing more detail of step 204 of FIG. 2 for identifying a balloon product and corresponding design data. The operation is continued from step 202, and in decision step 302, the system may determine whether it has received a user input. If at decision step 302, a user input is received, the system will continue to step 204 of FIG. 2.

If at decision step 302, no user input is received, in step 304, the system may monitor surroundings via one or more sensors. Sensors may include various electronic, mechanical, electromechanical, optical, or other devices that provide information related to external conditions and/or capture images of nearby objects in the environment. In decision step 306, the system may determine whether an identifier (e.g., watermarks, QR codes, and barcodes) or structure (e.g., size, shape, color, pattern, material, and the like) of a balloon is recognized. If at decision step 306, the system does not recognize an identifier or structure, the system will continue to monitor surrounds, step 304.

If at decision step 306, the system does recognize an identifier or structure of the balloon, at decision step 308, the system will determine whether it can identify the specific balloon product or model. If not, at step 310, the system may output a message to a user and inquire for more information. The system may then revert back to step 302 to determine whether a user input is received. If at decision step 308, a balloon product or model is identified, the system will continue to step 204 of FIG. 2.

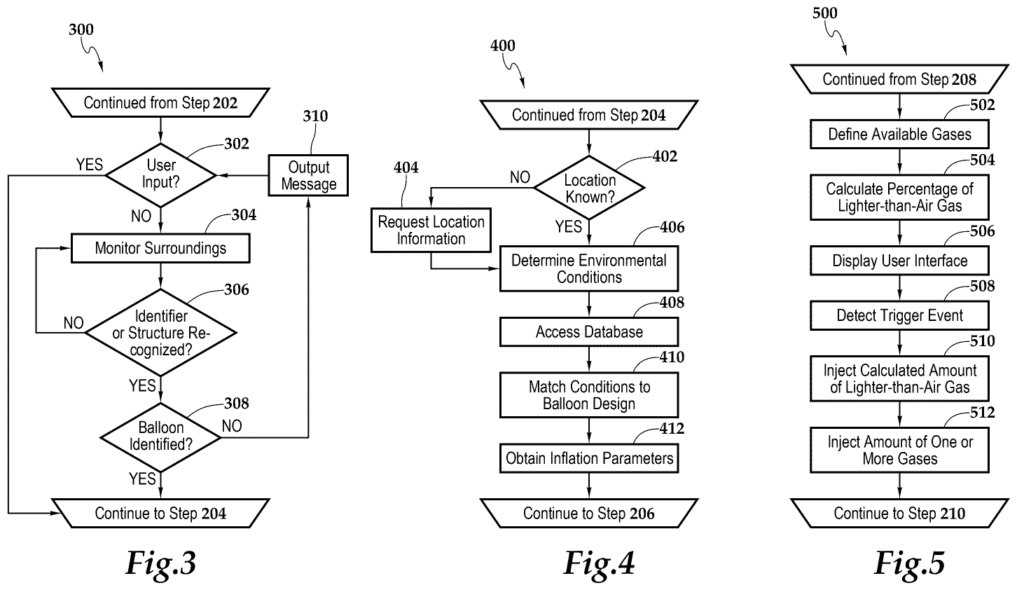

FIG. 4 is a flowchart 400 providing more detail of step 206 of FIG. 2 for obtaining location information and defining inflation parameters. The operation is continued from step 204, and in decision step 402, the system may determine whether a location is known. If at decision step 402, the location is not known, in step 404, the system may request location information. Specifically, the system may request location information from one or more components of the system, from a database accessible to the system, or from a third-party device. For example, the system may request location information from through use of a component's location-based features, such as GPS, WiFi access points, cell tower signals, and the like. In another example, location information may be requested from another device associated with the system, one that is not necessarily part of the system. In yet another example, location information vehicle may be requested through use of location-based features available on a user's portable electronic device, such as a smart phone, a wearable device, an IoT device, and the like.

If at decision step 402, the location is known, or once location information is obtained, at step 406, the system may determine environmental conditions. Examples of environmental conditions may include elevation and temperature. Other environmental conditions are contemplated, such as pressure, humidity, wind forces, time, precipitation, and the like.

At step 408, the system may access a knowledge base, such as knowledge base 110 of FIG. 1, that may include an information table for describing some of the information contained in the archive. Information table, archive, and any other database of the system are not to be construed as a limitation on the data format, data structure or database techniques used in the various embodiments. For example, the knowledge base may include relational database with a database access protocol using, but not limited to, Structured Query Language (SQL), Open Database Connectivity (ODBC), Java Database Connectivity (JDBC), or some equivalent, and the like.

In step 410, the system may be configured to match and/or associate environmental conditions to the identified balloon product's design data. In step 414, the system may obtain inflation parameters specific to the balloon product based on, for example, the design data, the environmental conditions, and/or the location information. The operation is then continued to step 206 of FIG. 2.

FIG. 5 is a flowchart 500 providing more detail of step 210 of FIG. 2 for executing an inflation process including injecting a defined amount of a lighter-than-air gas into the identified balloon product. The operation is continued from step 208, and in step 502, the system may define available gases for use during the inflation process. For purposes of this application, the available gases include at least one lighter-than-air gas and one or more other gases. For example, available gases may include helium and an electronegative gas to increase the overall dielectric strength of the inflation gas retained within the balloon. Examples of a dielectric gas may include hydrogen, ammonia, carbon monoxide, nitrogen, air, synthetic air, oxygen, chlorine, hydrogen sulfide, carbon dioxide, nitrous oxide, sulfur dioxide, trifluoromethane, tetrafluoromethane (R-14), tetrafluoroethane (R-134a), dichlorodifluoromethane (R-12), hexafluoroethane (R-116), sulfur hexafluoride (146) , hexafluoropropane (R-236fa), dichlorotetrafluoroethane (R-114), perfluoropropane (R-218), octafluorocyclobutane (R-C318), and perfluorobutane (R-3-1-10).

In step 504, the system may calculate a percentage of at least one lighter-than-air gas for injecting into the balloon based on the available gases, the design data, and/or location information. In step 506, the system may output a user interface on a display. Specifically, the system may output information corresponding to the received design data (e.g., balloon mass, balloon volume, etc.), location parameters (e.g., temperature, altitude, other ambient conditions, and the like), available gases, and calculated percentage of at least one lighter-than-air gas. It is further contemplated that the system may output information relating to costs associated with executing the inflation process and corresponding savings by using a minimum amount of the lighter-than-air gas to achieve optimal buoyancy based on design data and location parameters.

Generally, the user interface may include any suitable mechanism or component for receiving inputs from a user. For instance, user interface may include a capacitive touch assembly for receiving touch inputs from a user to, for example, adjust one or more values, such as the balloon lift. User interface may also include circuitry operative to convert (and encode/decode, if necessary) analog signals and other signals into digital data, for example in any manner typical of an electronic device of the type of electronic device.

In step 508, the system may detect a trigger event corresponding to initiating the inflation process. For example, the system may detect an input via the user interface. In another example, a trigger event may be recognized by one or more sensors of the system, such as a proximity sensor configured to detect the balloon proximate an outlet nozzle or tube. It is further contemplated that other sensors of the system may detect a trigger event, such as a temperature sensor, an ambient light sensor, a touch sensor, a magnetic sensor, pressure sensor, and/or other sensors.

In response to detecting the trigger event, in step 510, the system may inject the defined amount of a lighter-than-air gas into the balloon. Once the defined (minimum) amount of the lighter-than-air is injected, in step 512, the system may inject an amount of one or more supplemental gases based on the determined volume of the balloon. It is also contemplated that the injection of the one or more supplemental gases into the balloon may be based on a timer or correspond to internal pressure of the balloon. The operation is then continued to step 210 of FIG. 2.

### Exemplary Inflation System

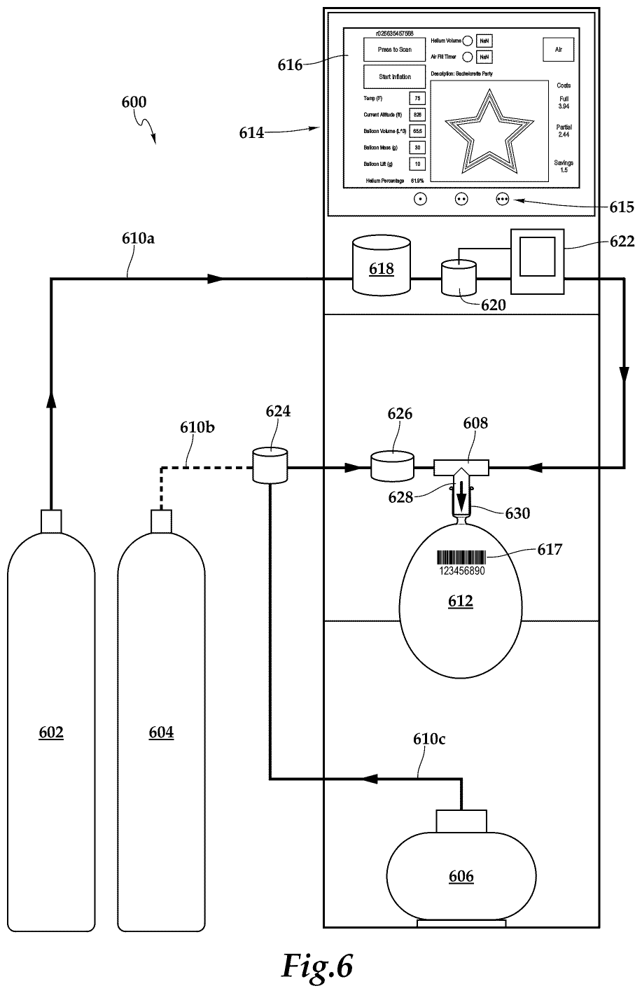

FIG. 6 illustrates an exemplary inflation system 600 that may be used to implement all or a portion of the operations according to the present disclosure. As shown, inflation system 600 may include a lighter-than-air (e.g., helium) source 602, a secondary gas (e.g., ultra-high purity nitrogen) source 604, and an air compressor 606.

Gas sources 602, 604 and/or air compressor 606 may include a two-stage regulator to, for example, efficiently manage and stabilize pressure by first reducing it to an intermediate level and then fine-tuning it to the desired output level. For example, a regulator of lighter-than-air source 602 may be set to 16 psi. In another example, a regulator of a secondary source 604 may be set to 60 psi. In yet another example, the output of air compressor 606 may be set to 60 psi.

As shown, gas sources 602, 604 and air compressor 606 may be in fluid communication to an outlet tube or nozzle 608 via one or more inlets 610a, 610b, 610c. Although secondary gas source 604 and air compressor 606 are illustrated, it is contemplated that inflation system 600 may include one or the other may be used as a supplemental gas for inflating a balloon 612. For instance, in one aspect, secondary gas source 604 may be used in place of air compressor 606.

As shown, inflation system 600 may further include a control panel 614. Control panel 614 may include a user interface 616 configured to display various parameters and attributes for optimizing an inflation process, as detailed herein. Control panel may further include one or more sensors 615 to, for example, scan an identifier 617 of balloon 612, as detailed above.

Moreover, control panel 614 may include a control valve 618 to facilitate regulating the flow of a lighter-than-air gas (e.g., helium) from source 602 via inlet 610a. Control valve 618 may include a variable orifice or a flow control mechanism to adjust the flow rate of gas accurately. It is further contemplated that control valve 618 may facilitate releasing excess pressure to, for example, prevent damage to system 600 and/or balloon 612 in case of overpressure situations.

As shown, control panel 614 may further include a flowmeter control valve 620 operatively coupled to a mass flowmeter 622. Mass flowmeter may be configured to continuously measures the flow rate of the fluid. This information may be displayed on a readout or transmitted to flowmeter control valve 620 or another component of system 600 for monitoring. Based on the measurement of fluid flow, the flowmeter control valve 620 may adjusts its position to regulate the flow rate. This ensures that the flow rate stays within the desired range or follows a specific setpoint, e.g., injecting a minimum amount of a lighter-than-air gas into balloon 612. In one aspect, an actuator or controller of system 600 may automatically adjust a position of control valve 620 based on information from mass flowmeter 622. This helps maintain precise control over the process without manual intervention. While flowmeter control valve 620 and mass flowmeter 622 are shown as separate components, it is contemplated that functions performed by these components may be integrated into a single device.

As further illustrated in FIG. 6, the flow of fluid from secondary source 604 and/or air compressor 606 may be regulated by supplemental gas control valve 624. Like control valve 618, supplemental gas control valve 624 may be configured to regulate the flow of a fluid (e.g., air or nitrogen) via inlets 610b, 610c. Supplemental gas control valve 624 may include a variable orifice or a flow control mechanism to adjust the flow rate of gas accurately. It is further contemplated that supplemental gas control valve 624 may facilitate releasing excess pressure to, for example, prevent damage to system 600 and/or balloon 612 in case of overpressure situations. Moreover, a pressure regulator 626, such as a Conwin regulator, may facilitate providing accurate and stable control of gas pressure. Particularly, pressure regulator 626 may provide precise control for low-pressure applications, with fine-tuning capabilities for accurate pressure management. In one aspect, pressure regulator 626 is set to 16 IWC.

As illustrated, inlets 610a, 610b, 610c may be fluidly connected to output tube 608. Output tube 608 may include a stem 628 shaped to receive neck 630 of balloon 612. Output tube 608 may include a clamping mechanism to seal neck 630 and prevent leakage of fluid during an inflation process. It is contemplated that any clamping mechanism may be used to create a seal in neck 630, such as a manual clamp, a spring clamp, and an adjustable pinch clamp.

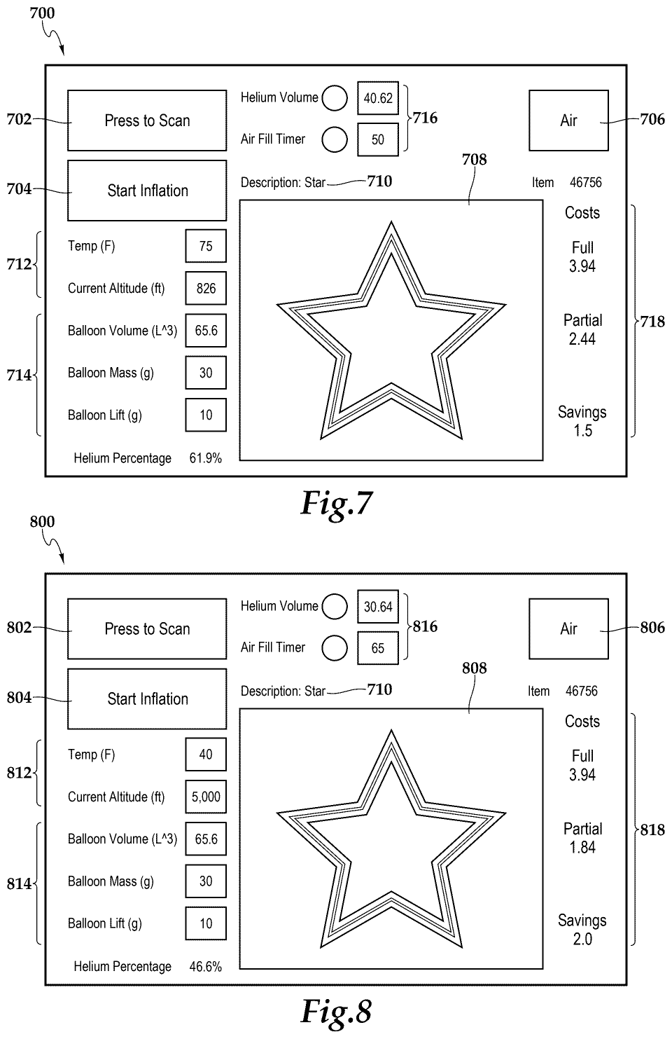

As detailed above, inflation system 600 may be configured to receive design data, obtain location information, and determine inflation parameters corresponding to balloon 612, including a minimum amount of lighter-than-air gas for executing an inflation process. As shown in FIG. 6, the information received, obtained, identified, and/or determined by system 600 may be output on user interface 616, as further detailed in FIGS. 7-8. In operation, the information is output on display 616 and the inflation process may begin automatically or in response to a user input.

Exemplary operation steps of inflation system 600 may receive and clamp—at shaft 628 of nozzle 608—a neck 630 of balloon 612. Inflation system 600 may facilitate opening control valve 618 to permit helium to flow through flowmeter control valve 620 and mass flowmeter 622 and into balloon 618 through nozzle 608. Then, once a defined (minimum) amount of helium is measured by flowmeter 622, control valve 620 will shut. Once control valve 620 is shut, inflation system 600 may be configured to open supplemental gas control valve 624 to permit a secondary gas (e.g., air or nitrogen) to flow into the balloon 618 through nozzle 608. Pressure regulator 626 may be configured to cut the flow of secondary gas based on, for example, a timer or a measured internal pressure of balloon 618. Once balloon 618 is filled, according to specific parameters available to inflation system 600, a user my unclamp neck 628 from shaft 628 of nozzle 608.

FIG. 7 and FIG. 8 illustrate exemplary user interfaces 700, 800 for outputting various parameters and attributes relating to an inflation process based on balloon design data and location information. As shown, user interfaces 700, 800 may include one or more components that a user may interact with to initiate one or more processes. For example, a “Press to Scan” interactive component 702, 802 may cause an optical sensor of the system to scan an identifier or structural features of a balloon. As another example, a “Start Inflation” interactive component 704, 804 may initiate an inflation process, as detailed above. As yet another example, an “Air” interactive component 706, 806 may open one or more valves of the system to inject air or a supplemental gas into the balloon.

User interfaces 700, 800 may further output display descriptive components, such as descriptive drawings that depict or describe a balloon. As shown in FIGS. 7 and 8, a descriptive drawing or graphical representation 708, 808 corresponding to a balloon identified by the system may be output to the user. For instance, if the system identifies the balloon to be inflated is star shaped, the system may access a database to obtain and output the graphical representation to a user. In addition, user interfaces 700, 800 may output a corresponding descriptive component 710, 810, such as a description of the balloon shape (e.g., “Star”) or other identifying information (e.g., item or model number).

As shown, user interfaces 700, 800 may further include one or more input fields. The system may automatically insert values corresponding to an input field based on, for example, information obtained or received from one or more components of the system or a third-party device. It is further contemplated that a user may manually input values into input fields, such as mouse clicks, typed text, touch, gestures, utterances, and the like. More specifically, fields of user interfaces 700, 800 may be location specific (e.g., “Temp (F)” and “Current Altitude”) fields 712, 812, balloon design (e.g., “Balloon Volume (L\hat{ }3),” “Balloon Mass (g),” and “Balloon Lift (g)”) specific fields 714, 814, and inflation process (“Helium Volume” and “Air Fill Timer”) specific fields 716, 816. Moreover, user interfaces 700, 800 may display callouts or captions 718, 818 corresponding to “Costs” (e.g., cost amount associated with lighter-than-air gas provided to the balloon) and “Savings” (e.g., savings amount associated with using a defined minimum lighter-than-air gas).

Exemplary user interface 700, 800 are illustrated for purposes of comparing parameters determined for an inflation process based on balloon design data and location information. More specifically, user interface 700 may correspond to an inflation process to be executed at a high temperature (causing helium to expand and become less dense) and low elevation (causing helium to be more compressed). As shown, location specific field 712 of user interface 700 include values of “75” for temperature and “826” for altitude. Based on this location information and the values shown in balloon design specific field 714, the system may be configured to determine values associated with inflation process specific fields 716. For instance, as shown, at high temperature and low elevation user interface 700 displays that an inflation process may include a first step of injecting a helium volume of “40.62” into the balloon and a second step of injecting air or a secondary gas for “50” seconds. Moreover, based on the values associated with the inflation process, user interface 700 may display captions or callouts 718 comparing costs of a balloon fully inflated with helium (“3.94”) with costs of a balloon receiving a partial or minimum amount of helium (“2.44”) as determined by the system and the corresponding savings (“1.5”).

On the other hand, user interface 800 may correspond to an inflation process to be executed at a low temperature (causing helium to contract and become denser) and high elevation (causing helium to expand). As shown, location specific field 812 of user interface 800 include values of “40” for temperature and “5000” for altitude. Based on this location information and the values shown in balloon design specific field 814, the system may be configured to determine values associated with inflation process specific fields 816. For instance, as shown, at low temperature and high elevation user interface 800 displays that an inflation process may include a first step of injecting a helium volume of “30.64” into the balloon and a second step of injecting air or a secondary gas for “65” seconds. Moreover, based on the values associated with the inflation process, user interface 800 may display captions or callouts 818 comparing costs of a balloon fully inflated with helium (“3.94”) with costs of a balloon receiving a partial or minimum amount of helium (“1.84”) as determined by the system and the corresponding savings (“2.0”). In other words, operations according to the present disclosure may facilitate optimizing an amount of each gas injected based on a design and location of the balloon and output an interface including costs, savings, and parameters relating to the location, design, and/or gaseous mixture.

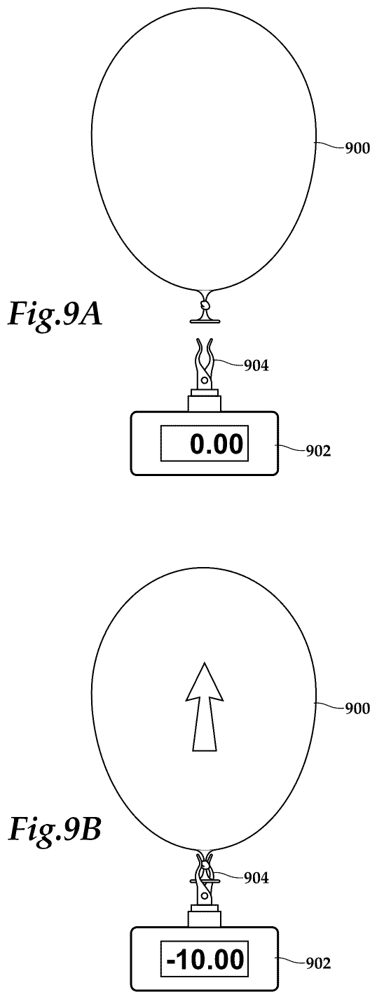

FIG. 9A and FIG. 9B illustrate a balloon 900 that has been inflated according to the above disclosure to obtain a desired balloon lift. More specifically, FIG. 9A illustrates scale 902 that has been calibrated to measure “0.0” grams. FIG. 9B illustrates inflated balloon 900 secured—such as via a clamp 904—secured to scale 902, which outputs a measurement of “−10.00” grams corresponding to the parameters of the inflation process used above in relation to user interface 700, 800.

### Exemplary Computer System

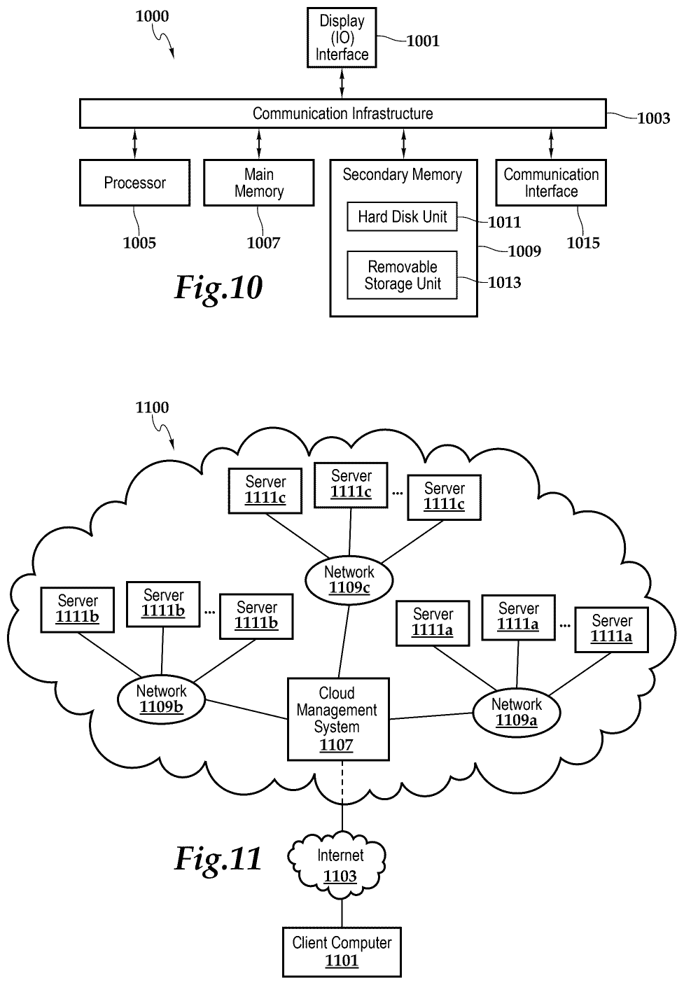

FIG. 10 illustrates a diagram of a system of which may be an embodiment of the present disclosure. Computer system 1000 includes an input/output interface 1001 connected to communication infrastructure 1003—such as a bus—, which forwards data such as graphics, text, and information, from the communication infrastructure 1003 or from a frame buffer (not shown) to other components of the computer system 1000. The input/output interface 1001 may be, for example, a display device, a keyboard, touch screen, joystick, trackball, mouse, monitor, speaker, printer, wearable device, web camera, any other computer peripheral device, or any combination thereof, capable of entering and/or viewing data.

Computer system 1000 includes one or more processors 1005, which may be a special purpose or a general-purpose digital signal processor configured to process certain information. Computer system 1000 also includes a main memory 1007, for example random access memory (RAM), read-only memory (ROM), mass storage device, or combinations of each. Computer system 1000 may also include a secondary memory 1009 such as a hard disk unit 1011, a removable storage unit 1013, or combinations of each. Computer system 1000 may also include a communication interface 1015, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that the main memory 1007, secondary memory 1009, communication interface 1015, or combinations of each, function as a computer usable storage medium, otherwise referred to as a computer readable storage medium, to store and/or access computer software including computer instructions. For example, computer programs or other instructions may be loaded into the computer system 1000 such as through a removable storage device, for example, a floppy disk, ZIP disks, magnetic tape, portable flash drive, optical disk such as a CD or DVD or Blu-ray, Micro-Electro-Mechanical Systems (MEMS), nanotechnological apparatus. Specifically, computer software including computer instructions may be transferred from the removable storage unit 1013 or hard disc unit 1011 to the secondary memory 1009 or through the communication infrastructure 1003 to the main memory 1007 of the computer system 1000.

Communication interface 1015 allows software, instructions and data to be transferred between the computer system 1000 and external devices or external networks. Software, instructions, and/or data transferred by the communication interface 1015 are typically in the form of signals that may be electronic, electromagnetic, optical or other signals capable of being sent and received by the communication interface 1015. Signals may be sent and received using wire or cable, fiber optics, a phone line, a cellular phone link, a Radio Frequency (RF) link, wireless link, or other communication channels. In certain embodiments, data is stored and transmitted according to block chain technology. A block chain may facilitate checking whether data is forged or falsified, by comparing block data (i.e., the medical data) stored in a plurality of node servers to the original data.

Computer programs, when executed, enable the computer system 1000, particularly the processor 1005, to implement the methods of the present disclosure according to computer software including instructions.

The computer system 1000 described may perform any one of, or any combination of, the steps of any of the methods according to the present disclosure. It is also contemplated that the methods according to the present disclosure may be performed automatically.

The computer system 1000 of FIG. 10 is provided only for purposes of illustration, such that the present disclosure is not limited to this specific embodiment. It is appreciated that a person skilled in the relevant art knows how to program and implement the present disclosure using any computer system.

The computer system 1000 may be a handheld device and include any small-sized computer device including, for example, a personal digital assistant (PDA), smart hand-held computing device, cellular telephone, or a laptop or netbook computer, handheld console or MP3 player, tablet, or similar hand held computer device.

### Exemplary Cloud Computing System

FIG. 11 illustrates an exemplary cloud computing system 1100 that may be an embodiment of the present disclosure. The cloud computing system 1100 includes a plurality of interconnected computing environments. The cloud computing system 1100 utilizes the resources from various networks as a collective virtual computer, where the services and applications can run independently from a particular computer or server configuration making hardware less important.

Specifically, the cloud computing system 1100 includes at least one client computer 1101. The client computer 1101 may be any device through the use of which a distributed computing environment may be accessed to perform the methods disclosed herein, for example, a traditional computer, portable computer, mobile phone, personal digital assistant, tablet to name a few. The client computer 1101 includes memory such as random-access memory (RAM), read-only memory (ROM), mass storage device, or any combination thereof. The memory functions as a computer usable storage medium, otherwise referred to as a computer readable storage medium, to store and/or access computer software and/or instructions.

The client computer 1101 also includes a communications interface, for example, a modem, a network interface (such as an Ethernet card), a communications port, a PCMCIA slot and card, wired or wireless systems, etc. The communications interface allows communication through transferred signals between the client computer 1101 and external devices including networks such as the Internet 1103 and cloud data center 1105. Communication may be implemented using wireless or wired capability such as cable, fiber optics, a phone line, a cellular phone link, radio waves or other communication channels.

The client computer 1101 establishes communication with the Internet 1103—specifically to one or more servers—to, in turn, establish communication with one or more cloud data centers 1105. A cloud data center 1105 includes one or more networks 1109a, 1109b, 1109c managed through a cloud management system 1107. Each network 1109a, 1109b, 1109c includes resource servers 1111a, 1111b, 1111c, respectively. Servers 1111a, 1111b, 1111c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud management system 1107 can comprise a dedicated or centralized server and/or other software, hardware, and network tools to communicate with one or more networks 1109a, 1109b, 1109c, such as the Internet or other public or private network, with all sets of resource servers 1111a, 1111b, 1111c. The cloud management system 1107 may be configured to query and identify the computing resources and components managed by the set of resource servers 1111a, 1111b, 1111c needed and available for use in the cloud data center 1105. Specifically, the cloud management system 1107 may be configured to identify the hardware resources and components such as type and amount of processing power, type and amount of memory, type and amount of storage, type and amount of network bandwidth and the like, of the set of resource servers 1111a, 1111b, 1111c needed and available for use in the cloud data center 1105. Likewise, the cloud management system 1107 can be configured to identify the software resources and components, such as type of Operating System (OS), application programs, and the like, of the set of resource servers 1111a, 1111b, 1111c needed and available for use in the cloud data center 1105.

The present disclosure is also directed to computer products, otherwise referred to as computer program products, to provide software to the cloud computing system 1100. Computer products store software on any computer useable medium, known now or in the future. Such software, when executed, may implement the methods according to certain embodiments of the present disclosure. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (MEMS), nanotechnological storage device, etc.), and communication mediums (e.g., wired and wireless communications networks, local area networks, wide area networks, intranets, etc.). It is to be appreciated that the embodiments described herein may be implemented using software, hardware, firmware, or combinations thereof.

The cloud computing system 1100 of FIG. 11 is provided only for purposes of illustration and does not limit the present disclosure to this specific embodiment. It is appreciated that a person skilled in the relevant art knows how to program and implement the present disclosure using any computer system or network architecture.

Further modifications and alternative embodiments of various aspects of the present disclosure will be apparent to those skilled in the art in view of this description. Accordingly, this description is to be construed as illustrative only and is for the purpose of teaching those skilled in the art the general manner of carrying out the present disclosure. It is to be understood that the forms of the present disclosure shown and described in the application are to be taken as examples of embodiments. Components may be substituted for those illustrated and described in the application, parts and processes may be reversed, and certain features of the present disclosure may be utilized independently, all as would be apparent to one skilled in the art after having the benefit of this description of the present disclosure. Changes may be made in the elements described in the application without departing from the spirit and scope of the present disclosure as described in the following claims.

1. A system comprising:
a processor;
a non-volatile, non-transitory memory in communication with the processor via a communication infrastructure, said memory including stored instructions that, when executed by said processor, cause said processor to:
receive design data corresponding to a balloon, said design data including at least one of a balloon volume and a balloon mass;
obtain one or more environmental conditions corresponding to a location of said balloon, said one or more environmental conditions including at least one of an elevation and a real-time temperature;
determine a minimum amount of a lighter-than-air gas for inflation of said balloon based on said design data and said one or more environmental conditions; and
execute an inflation process including providing, via an outlet tube, the determined minimum amount of said lighter-than-air gas followed by one or more gases to create a mixture within the balloon corresponding to said design data and said environmental conditions.

2. The system of claim 1, further comprising one or more sensors configured to obtain said design data based on an identifier of said balloon.

3. The system of claim 1, further comprising one or more sensors configured to obtain said design data based on analyzing a structure of said balloon.

4. The system of claim 1, wherein said design data is manually input by a user.

5. The system of claim 1, wherein said processor is further operatively coupled to a geolocation or GPS sensor for obtaining one or more environmental conditions corresponding to a location of said balloon.

6. The system of claim 1, wherein said processor is further operative to communicate with a third-party device of a user for obtaining said one or more environmental conditions corresponding to a location of said balloon.

7. The system of claim 1, wherein said gas mixture is injected into said balloon in response to detection of said balloon proximate said outlet tube, and further including a regulator configured to measure an internal pressure of said balloon and switch between said lighter-than-air gas and said one or more gases.

8. The system of claim 1, further comprising a display configured to output values corresponding to said design data and said one or more environmental conditions.

9. The system of claim 8, wherein said display is further configured to output a cost amount associated with said lighter-than-air gas provided to the balloon.

10. The system of claim 8, wherein said display is further configured to output a savings amount associated with said lighter-than-air gas provided to the balloon.

11. A method comprising:
receiving design data corresponding to a balloon, said design data including at least one of a balloon volume and a balloon mass;
obtaining one or more environmental conditions corresponding to a location of said balloon, said one or more environmental conditions including at least one of an elevation and a real-time temperature;
determine a minimum amount of a lighter-than-air gas for inflation of said balloon based on said design data and said one or more environmental conditions; and
execute an inflation process including providing, via an outlet tube, the determined minimum amount of said lighter-than-air gas followed by one or more gases to create a mixture within the balloon corresponding to the design data.

12. The method of claim 11, wherein said receiving step further comprises to obtaining, via one or more sensors, said design data based on an identifier of said balloon.

13. The method of claim 11, wherein said receiving step further comprises to obtaining, via one or more sensors, said design data based on analyzing a structure of said balloon.

14. The method of claim 11, wherein said design data is manually input via a user interface.

15. The method of claim 11, wherein said one or more environmental conditions is obtained via a geolocation or GPS sensor configured to determine a location of said balloon.

16. The method of claim 11, wherein said one or more environmental conditions is obtained from a third-party device configured to determine a location of said balloon.

17. The method of claim 11, wherein executing step includes injecting said gas mixture to said balloon in response to detecting said balloon proximate said outlet tube, said outlet tube including a regulator configured to measure an internal pressure of said balloon and switch between said lighter-than-air gas and said one or more gases.

18. The method of claim 11, further comprising outputting values, via a display, corresponding to said design data and said one or more environmental conditions.

19. The method of claim 18, wherein said outputting step further includes displaying a cost amount associated with said lighter-than-air gas provided to the balloon.

20. The method of claim 18, said outputting step further includes displaying a savings amount associated with said lighter-than-air gas provided to the balloon.
